(19) United States
(12) Patent Application Publication
(10) Pub. No.: US 2016/0334093 A1
(43) Pub. Date: Nov. 17, 2016

(54) MULTIPLE EMISSION SOURCE MULTIPLE COOLING PATH LIGHTING SYSTEM AND METHOD

(71) Applicants: Thomas Stack, Oxford, MI (US); Ted Huff, Ferndale, MI (US)

(72) Inventors: Thomas Stack, Oxford, MI (US); Ted Huff, Ferndale, MI (US)

(73) Assignee: Q Technology, Inc., Livermore, CA (US)

(21) Appl. No.: 15/069,960

(22) Filed: Mar. 14, 2016

Related U.S. Application Data
(63) Continuation-in-part of application No. 13/916,573, filed on Jun. 12, 2013, now Pat. No. 9,285,081.
(60) Provisional application No. 62/162,702, filed on May 16, 2015.

(51) Int. Cl. F21V 29/83; F21V 29/74; B29D 11/00; F21V 7/22; F21S 8/06; F21V 31/00; F21V 29/67; F21V 21/008

(52) U.S. Cl. CPC F21V 29/83; F21V 29/67; F21V 29/74; F21V 21/008; F21V 7/22; F21S 8/061; F21V 31/005; B29D 11/00355; F21Y 2115/10

(57) ABSTRACT

A luminaire featuring LEDs is disclosed. Each LED is affixed to a support structure and may have an individual reflector or refractor subsystem to modify light output. Multiple air vents or radiators are provided to even the temperature distribution between LEDs. In one embodiment, the support structure is arranged as a framework of bridges between LEDs with air gaps in between bridges. A fan may be provided to further enhance cooling. The LEDs and fan may have internal or external control means, including possibly wireless means. Alternative embodiments are also disclosed.

This application is a Continuation-In-Part Application of a U.S. application Ser. No. 13/916,573, filed on Jun. 12, 2013, entitled “LED High Bay Lighting Source”, that issued as U.S. Pat. No. 9,285,081 on Mar. 15, 2016. The Ser. No. 13/916,573 application, in turn, claims the benefit of priority under 35 USC sections 119 and 120 of a U.S. provisional patent application Ser. No. 61/659,398, filed on Jun. 13, 2012, also entitled “LED High Bay Lighting Source”. Further, this application also claims the benefit of priority under 35 USC sections 119 and 120 of a U.S. provisional patent application Ser. No. 62/162,702, filed on May 16, 2015, entitled, “Multiple Point Source Multiple Vent Light Structure.”

The entirety of the above mentioned applications are all incorporated herein by reference and priority of each is claimed herein. The applicant claims benefit to Jun. 13, 2012 as the earliest priority date.

### BACKGROUND

This invention relates to lighting systems, and more particularly, luminaires such as for High Bay deployments which are elevated to illuminate an extended area.

High Bay luminaires have found use in illuminating large rooms such as warehouses, or large expanses such as under a gas station canopy. Alternative uses include, but are not limited to, illuminating a construction area, assembly area, or sales area.

Historically, High Bay luminaires were generally made of one bulk incandescent or fluorescent light source within a large central reflector of substantially parabolic cross section. A cross section of this type design is exemplified in FIG. 1A, an illustration based on U.S. Pat. No. 2,418,195, which is herein incorporated by reference. This diagram features a luminaire 101A with light source 10, reflector 11, and rays 12. While U.S. Pat. No. 2,418,195 envisioned a linear fluorescent tube light source 10 having a circular cross section, the cross sectional FIG. 1A could also illustrate a substantially spherical bulb source as element 10, and a substantially dome shaped reflector as element 11. In this Figure, a mounting structure for lighting source 10 is not shown, as means of mounting a conventional light source are well known in the art. Other prior art sources that could perform in the role of depicted central light source 10 include an incandescent, halide, or mercury vapor bulb.

FIG. 1B exemplifies the cross section of a desired illumination pattern 101B produced by at least some legacy sources such as 101A. This graph represents amplitude variations along a lit plane surface under the luminaire 101A. The center peak is referenced to a center line projected on a plane directly underneath the light source. In the graph, the light amplitude reduces farther from the center toward periphery of the lit surface plane. In other words the ground illumination level will typically decrease with increasing distance away from directly under a bulb center.

Although LEDs are generally more energy efficient and reliable than previous generation sources, LEDs rarely if ever are plug-in replacements for earlier type light sources. For one thing, at least some energy efficient LEDs produce an order of magnitude less light output than did previous generation incandescent or fluorescent bulbs. With this lower intensity, a need exists to collectively use a multitude of LEDs to produce sufficient light to replace a previous generation source.

### SUMMARY

However, while multiple LEDs can increase light quantity, this does not automatically guarantee light quality. To distinguish from legacy technology such as incandescent and fluorescent bulbs which tend to emit omnidirectionally, LED point light sources differ in that LEDs tend to act as directional light sources with peak output along a projecting central axis.

As a result, some prior art multiple LED illumination sources exemplified in FIG. 2A (with LEDs 210 supported by a structure 205) have a drawback. As a result of LED directivity, some previous LED based lighting systems as represented in FIG. 2A have undesired optical “hot spots”. These spots appear as one or more illumination zones with significantly (sometimes as much as an order of magnitude) increased brightness compared to neighboring illumination regions. In other words, hot spots manifest as irregularly brighter light intensity variations across an illumination pattern. The FIG. 2B graph 201B represents a hypothetical lighting amplitude pattern where hot spots are shown as peaks 215. To associate FIGS. 2A and 2B, arrows 212 represent ray intensity peaks directing from individual LEDs 210 toward hot spots 215 in graph 201B.

In contrast, returning to FIG. 1B, lighting patterns from previous generation non-LED sources tend to gradually transition from a central brightness peak to less brightness at lighting zone periphery, thus presenting a smoother brightness pattern without “hot spots”. This more even illumination pattern from legacy lighting systems is also desirable in LED systems.

Lighting hot spots, which result from comparatively high emission levels emerging at one or more angles from a light fixture, are disadvantageous and potentially unsafe. Staring at a high brightness hot spot source for even a brief time can be uncomfortable and possibly cause eye damage. Moderating hot spots would both improve aesthetics and reduce distraction from hot spot illumination irregularity, as well as improve safety for people who might directly view a hot spot source.

Even a single hot spot resulting from an LED design may be undesirable. For example, often lighting designs based on one or more COB (chips on board) LED packages feature one or more concentrated central sources that are unpleasant if not damaging to the eyes when viewed directly along the COB primary illumination angle.

One known method in the art to generate a uniform lighting pattern without hot spots is to use a diffuser. However, a diffuser will often scatter light in directions not needed for general illumination.

It would be ideal to have a luminaire featuring LED energy efficiency, while producing a light output level similar to previous generation High Bay luminaires. There remains a need in the art to produce sufficient brightness comparable to a bulk legacy light source with a corresponding large reflector, without lighting hot spots.

This need is met by the present invention, which uses multiple localized point-like sources along with localized light directors. The overall illumination patterns of the present invention are generally even and lack hot spots, without using a diffuser.

In a preferred embodiment, the localized point-like sources are affixed to a plate, with light directors affixed on or integral to the plate. A primary benefit of this lighting configuration is that many smaller distributed light sources are less likely to produce glare or be harmful to the eyes with direct viewing, as may occur with prior art lighting designs having greater brightness with fewer sources.

In summary, preferred embodiments of this lighting fixture invention apply LEDs to benefit from their energy efficiency, while producing a light output level and distribution pattern similar to previous High Bay luminaires based on earlier generation fluorescent and incandescent sources.

Beyond lighting pattern comparisons, some other LED based luminaires are cooled through air circulation around fins surrounding luminaire exterior surfaces. One unfortunate consequence of these prior art designs is that air flow tends to follow a luminaire's outer surface, causing disadvantageous heat transfer from the light emitting area to elsewhere around the luminaire.

For example, FIG. 3A represents an airflow pattern 351 occurring around one such prior art luminaire 301, observed using smoke traces. Thermally, several effects may occur from the luminaire configuration and resulting airflow. Luminaire 301A has fins 315 which release heat from the luminaire internals, the heat then being absorbed by airflow 351. The warmed air then travels up the sides of luminaire 301.

FIG. 3B shows heat distribution measured 45 minutes after turn on of this prior art luminaire 301′, the prime symbol being used to denote the luminaire 301 after self-heating. The rectangular boxes 372A through 372D represent thermocouple meters, while curved line 371A represents a thermocouple wire attached to a fin 315 and the curved lines 371B, 371C, and 371D represent thermocouple wires routing to points within the luminaire 301′.

In comparison with the ambient room temperature of under 25 degrees C., the measured values 66, 89.4, 92.6, and 76.8 degrees C. shown by the thermocouple meters 372A through 372D respectively reveal temperatures that would shorten the life of electrical components. Beyond airflow redistribution of heat between prior art luminaire regions, another possible reason for this adverse heat distribution could be that fins lose efficiency with increasing distance from a central heat source. At a distance, fins may run cooler and draw less heat away from a central heat buildup in these prior art designs. In sum, possibly the airflow pattern shown in FIG. 3D more so serves to spread heat around the prior art luminaire rather than to remove heat overall.

For more effective heat removal, localized light sources and light directors may be inventively cooled with an LED support plate having channel vents to facilitate heat sink airflow. This novel heat sink configuration permits air to flow through holes or perforations, perhaps guided by a cooling fan.

In some settings, actively driven air flow through the inventive luminaire with heat sink air holes may solve a further problem. Since warmer air tends to rise, within a room or other enclosed space cooler air will tend to settle toward the floor leaving warmer air toward the ceiling. This formation of air temperature layers at varying height levels is called stratification and can waste heating energy when warm air rises above the level of room occupants. To reverse this, a fan guided air system can send warm air from higher levels in a room down to lower levels, opposing the trend of warm air rising toward higher levels. In other words, this mode of luminaire use may result in thermal destratification. Again, some users may find a more uniform air temperature distribution at various heights to be desirable.

Further details and advantages of the inventive lighting system will proceed in the discussion to follow. However, it should be kept in mind that not all of the advantages described above need be present in a single embodiment.

### BRIEF DESCRIPTION OF THE DRAWINGS

FIG. 1A shows an example prior art High Bay lighting source and optical pathways.

FIG. 1B represents a desired illumination pattern produced by some prior art legacy bulb luminaires.

FIG. 2A represents a prior art combination of discrete LED sources, and FIG. 2B represents a typical illumination pattern generated by a source such as FIG. 2A.

FIG. 3A shows a representative airflow pattern around a prior art LED luminaire.

FIG. 3B shows a thermal profile of the same prior art LED luminaire after self-heating.

FIG. 4A is a side elevation view of a luminaire according to the invention, and FIG. 4B is a cutaway view.

FIG. 5A shows a luminaire side elevation view with cutaway base section and FIG. 5D shows a base section perspective view, while FIGS. 5B and 5C respectively show side elevation and perspective views of the same smaller portions of 5A and 5D.

FIGS. 6A through 6E show variations on an elementary optical unit of the luminaire.

FIG. 7A shows a possible configuration for airflow holes placed around LEDs, and FIGS. 7B through 7E show possible airflow hole cross sections, while FIGS. 7F and 7G show use of a convection channel insert.

FIGS. 8A-C show a possible arrangement to distribute LEDs and airflow holes at regular spacings, each figure showing a different layer (plate, PCB, and heat sink).

FIGS. 9A-B show elevation view cross sections of various plate assembly layers, that together cooperate to provide heat relief through radiated emission and airflow.

FIG. 10 shows a resulting heat profile for a multiply vented luminaire plate in operation.

FIGS. 11A-B show lighting system perspective views as would be appropriate for use in a building or canopy lighting application, together with various physical support means.

FIGS. 12A-D show various details of a system capable of support by a hook or cable.

FIGS. 13A-C show alternative heat sink variations.

FIG. 14A shows a guided air configuration to enhance cooling, while FIG. 14b shows a modified plate cross section.

FIGS. 15A and 15B show alternative reflector configurations.

FIGS. 16A and 16B show how an example luminaire could be used to project light from a pole.

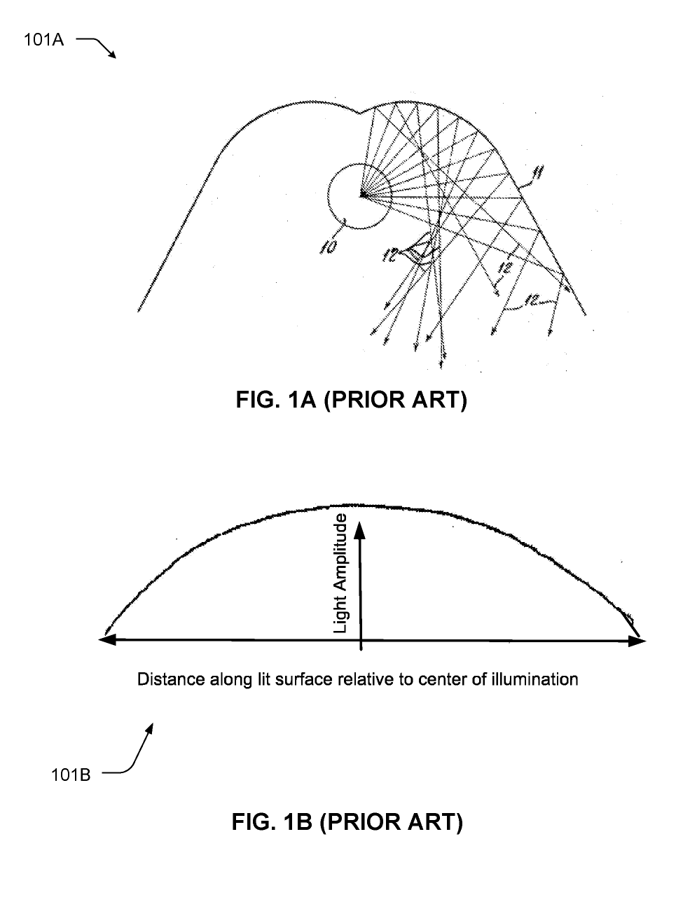

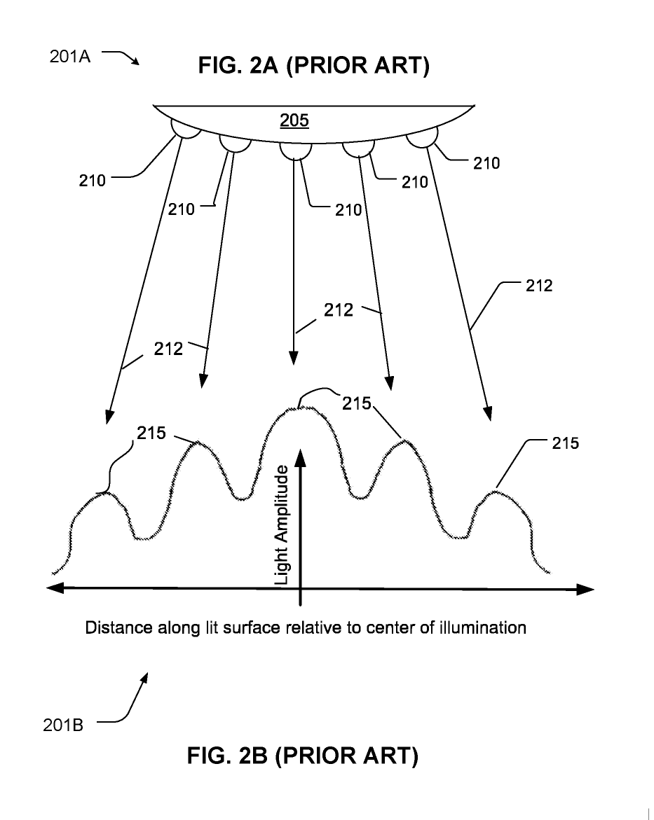

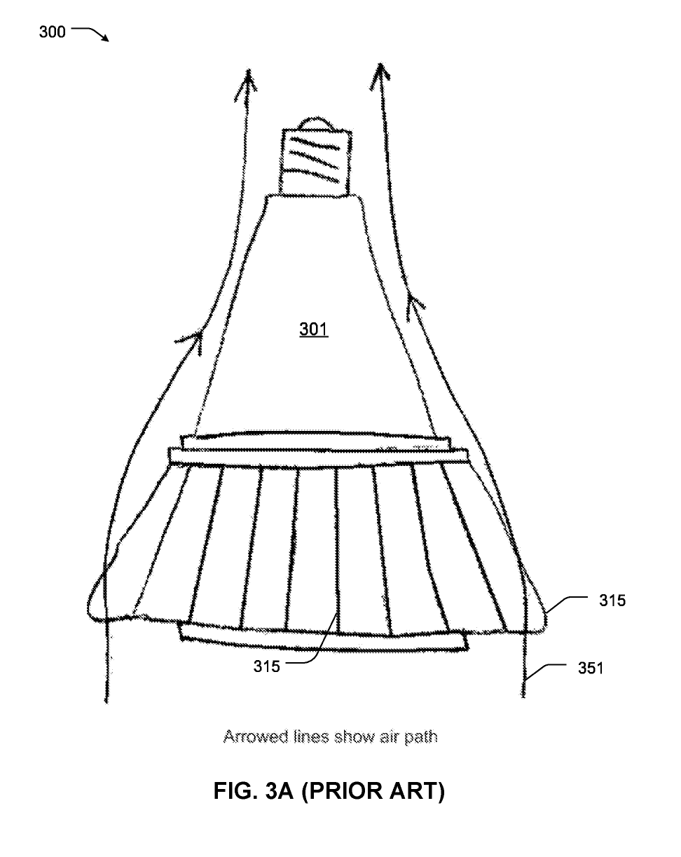

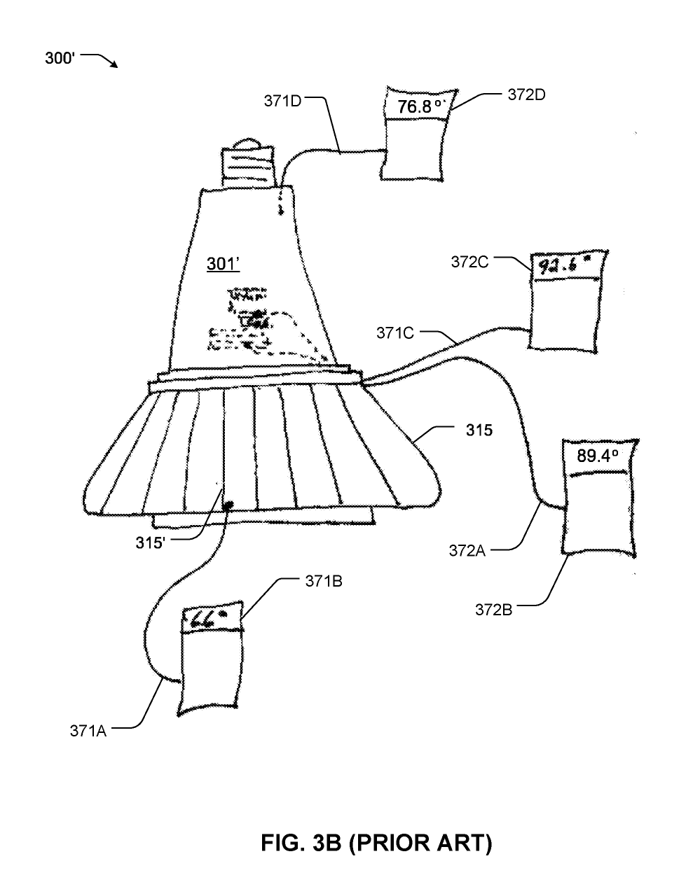

### DETAILED DESCRIPTION

### Terminology

Many existing luminaires provide whole-unit housing around internal functional and support components. To clarify terminology within this disclosure, however, a distinction will be made in that a term is needed for individual sub-housings to be used for individual LEDs or similar point-like sources.

In general optics practice, the term “optical cavity” usually means a set of mirrors for producing a standing wave. To contrast, here an optical hollow will mean a structure or “sub-housing” to facilitate redirection of light from an individual source, or subset of individual sources, rather than the entirety of sources within a luminaire.

Also, the terminology “above” and “below”, or “up” and “down” is relative, and intended for the convenience of referring to the drawings. These terms are not meant to limit the possible orientations in which an assembly may be deployed, but simply to serve as convenient descriptions within a drawing frame of reference.

### Overall Luminaire Design

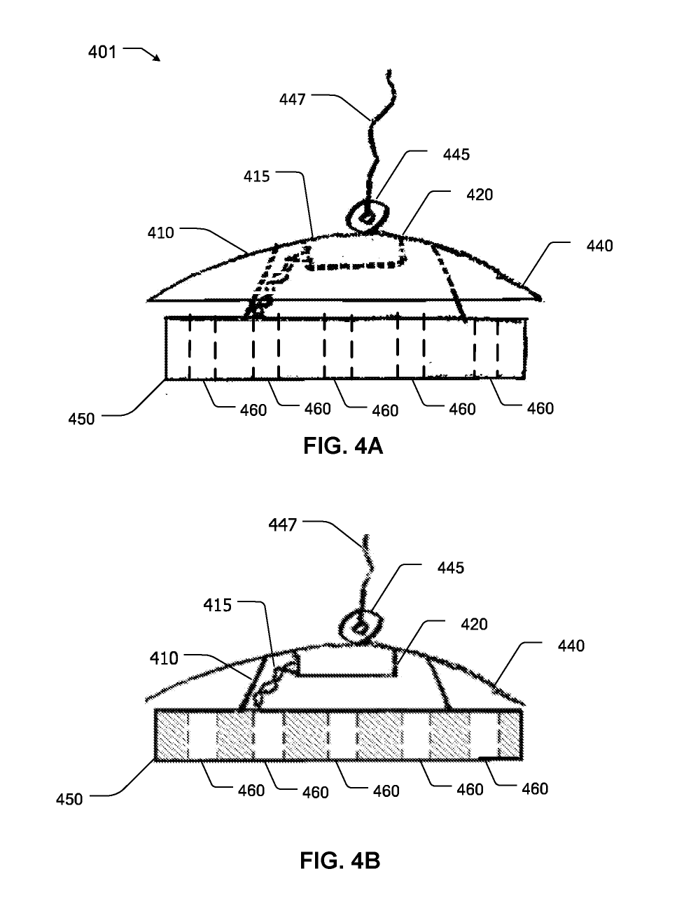

Turning now to FIG. 4A, an exemplary luminaire 401 with multiple vent system 450 according to the present invention is shown in side elevation view. Struts 410, power box 420, and wires 415 shown in dotted line format behind a dust cover 440. A support cable 447 is shown attached to eyelet 445. The multiple vent system 450 comprises vents 460, shown here between pairs of dashed lines because the vents exist behind the surface presented to the viewer in this Figure.

Turning now to FIG. 4A, an exemplary luminaire 401 with multiple vent system 450 according to the present invention is shown in side elevation view. Struts 410, power box 420, and wires 415 shown in dotted line format behind a dust cover 440. A support cable 447 is shown attached to eyelet 445. The multiple vent system 450 comprises vents 460, shown here between pairs of dashed lines because the vents exist behind the surface presented to the viewer in this Figure.

FIG. 4B represents the same features as in FIG. 4A but in cutaway view with dust cover 440 and plate 450 being shown in cross section.

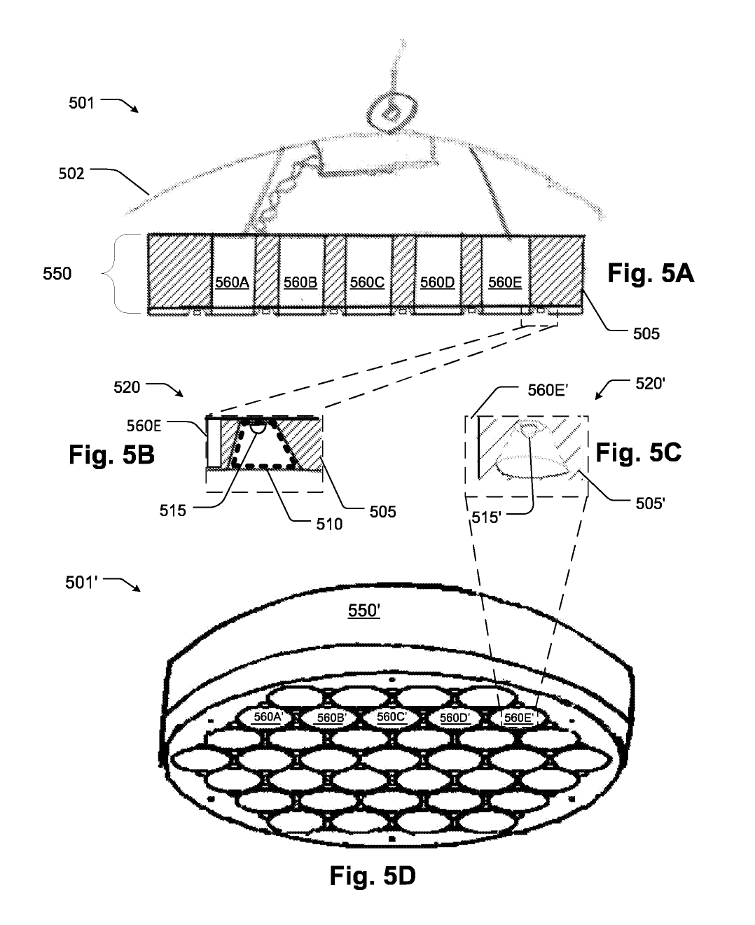

FIG. 5A depicts a luminaire side elevation view 501, showing a cutaway base section 550 with LEDs 515, labeled air vents 560A through 560E, and labeled optical hollow 505.

FIG. 5D shows a perspective view 501′ of the luminaire base 550. The air vents 560A through 560E in FIG. 5A are shown in corresponding perspective view in FIG. 5D.

Both FIGS. 5A and 5D have dashed insets which lead to dashed boxes in FIGS. 5B and 5C. In other words, FIGS. 5B and 5C respectively show magnified side elevation and perspective views of smaller portions of 5A and 5D.

### Optical Hollow and LED Sub-Housing

To illustrate a small-scale portion of the base for producing desired light emission, FIG. 5B features a section of an optical plate 505 in cross section, with a hollow 510 outlined by a dotted line. One purpose of the hollow 510 is to redirect light from an LED 515 placed within. Preferably, this hollow 510 is characterized by a narrower cross section toward the top as compared toward the bottom of the plate. The surface of the hollow 510 may be made of or coated with reflective material. Due to geometry the thickness of plate 505 and spacing between hollows 510 may constrain the possible angles of sides of each hollow 510 before hollows begin to overlap. Also very shallow angles for an optical hollow 510 may not be practical because that might lead to overlap with neighboring vents 560.

FIGS. 5B and 5C show magnified views corresponding to the same truncated cone optical hollow design 510 within a solid plate material 505, but from different perspectives. The elementary optical hollow 510 portrayed in FIGS. 5B and 5C may be repeated many times to construct a luminaire. While the LED 515 shown in the example hollow 510 has a rounded shape, other LED shapes including rectangular shapes may be used. The cross section 510 of an optical hollow need not be made symmetrical, depending on the overall desired light distribution from the totality of LEDs and hollows.

Although preferably a reflective metallic substance such as aluminum may be used for the support plate 505, alternatively any material with a reflective coating could be used, provided it has a sufficiently high temperature rating to handle above ambient temperatures produced by LEDs and support electronics. While a metallic reflector is envisioned, a white material may reflect enough light from sides of a hollow 510 to be useful. The plate 505 may be made via extrusion, as a die cast, or mechanical or laser cut from a sheet or block of material.

If an electrically conductive material is used for the plate 505, the hollow 510 need extend from the bottom to the top surface of the plate 505 to allow lighting components 515 on one side of the plate to be visible from the other side of the plate. This extended hollow allows enough separation between lighting components 515 and plate 505 material (if electrically conductive) to prevent a short circuit.

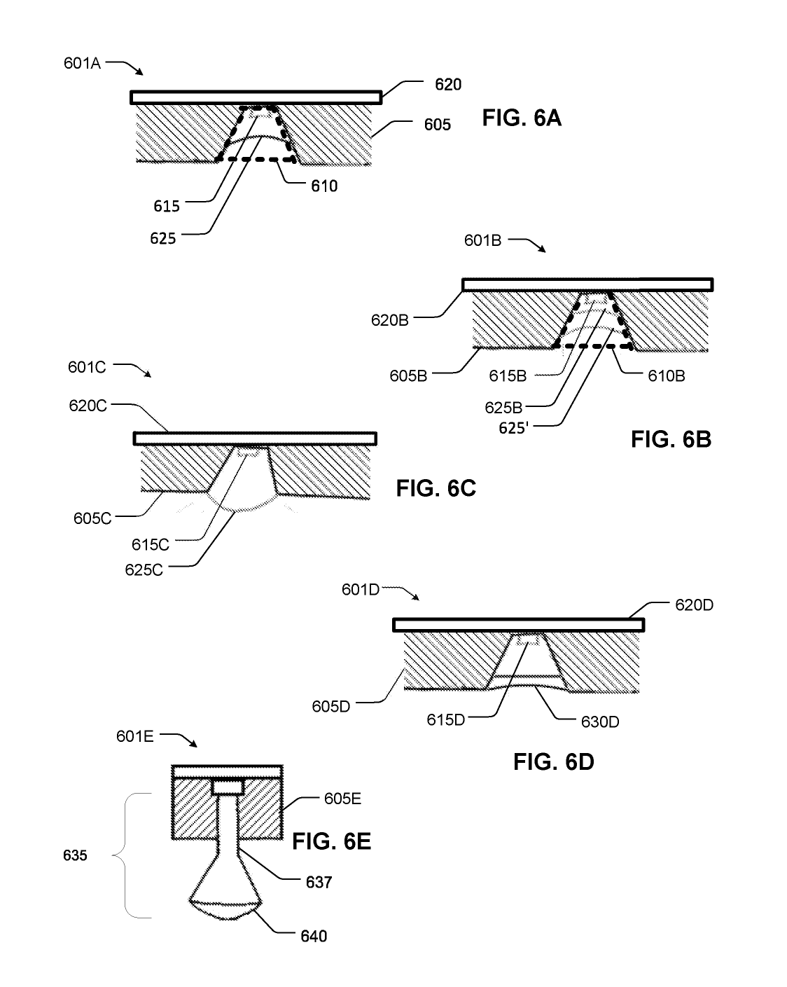

Optionally, several versions of additional refractive optics may be placed within the basic optical unit 520 shown in FIG. 5B. In FIG. 6A, LED 615 is shown supported by a planar circuit board 620 adjacent to the plate 605. Further a light directive material 625 is shown deposited within the hollow 610. Several different realizations are possible as shown in FIGS. 6B through 6E. In FIG. 6A, and FIGS. 6C through 6E, one layer of refractive material is used.

The material used to construct light directive material 625 may be formed as a solid prior to construction, or during construction as a liquid that transitions to a solid after being applied to a hollow 610. In some liquid fill configurations, whether through overfill or the meniscus-forming cohesion characteristic of the material poured or injected into the hollow, a curved shape may result before or upon solidification which would further disperse emitted light.

Optionally, a light transmissive liquid or solid may be placed over the concave reflector 605 and/or LED 615 to produce light director 625. The light directive material 625 need not be inserted into hollow 610 as a solid. As featured in FIG. 6C, if a liquid is poured in or injected to the hollow 610, as a characteristic result of liquid in contact with the plate 605C material or its coating if present, the liquid may form meniscus 625C. For this process, a liquid would preferably be applied with the plate 605 and circuit board 620 turned with the hollow 610 (as shown in FIG. 6A) facing upward from the ground, upside down from the preferred orientation for High Bay lighting use. The meniscus 625C, a curved surface interface with the air and solid surroundings, results from differences between cohesion of the liquid to itself and adhesion to surrounding material. This meniscus 625C may have a beneficial refractive nature, contributing to light redirection. Use of an optical element featuring inherent liquid meniscus formation may reduce or eliminate machining and/or mold making and casting steps that might otherwise be needed to produce a light redirector from solid material. Once a meniscus made of material in a liquid form solidifies to make a concave light director as in 625 as in FIG. 6A, or convex light director 625C as in FIG. 6C, it would then be ready for use with the hollow 610 facing downward.

As shown in FIG. 6C, the meniscus 625C need not be symmetrical, which could happen for example if the plate is tilted slightly during solidification. An asymmetrical meniscus 625C may beneficially provide desirable light redirection in combination with other light emitting hollows and associated light redirectors.

If starting as a liquid, the light transmissive material may be epoxy, for example, which chemically hardens to a solid. As another example, the light transmissive material may be acrylic glass which upon cooling hardens to a solid. Either material may be introduced in liquid form to make the meniscus refractor interface. Other known light transmissive materials that transition from liquid to solid form under known conditions may be used.

However, care should be taken that the transparent material's melting point be higher than the luminaire operating temperature.

Another possible configuration results from using no liquid, or insufficient liquid, to fill the hollow. In this case, a solid lens 630D may be placed over the hollow as in FIG. 6D.

As yet another possible configuration, FIG. 6E shows a light redirector 635 configured as a shaft 637 emerging from the plate, going to a disperser portion 640.

Several layers may comprise the optical redirector as shown in FIG. 6B. More than one layer could be poured or injected into the hollow 610, each layer possibly with a different refractive index. Alternatively, a lens material may be specially fabricated to fit into the hollow 610B, in which case region 625B represents an air gap between the lens 625′ and LED 615B.

The cross sections shown in the figures are representative only. The hollow size and geometry may be adjusted to vary surface area for the rated LED power as well as optical brightness and pattern. While FIGS. 6A through 6D show an LED placed within a conical hollow, the conical hollow shape is for example only and may be modified to produce alternate lighting profiles.

In a preferred embodiment, each LED is selected to operate at a power level of several watts and each hollow is made several millimeters across. In general, a higher wattage LED will need a larger reflector hollow. Some sample LEDs that could be used are the CREE XB-D series, for example selected from the series of 1 to 3 watt versions. These particular LEDs may be run at 1.5 watts to optimize the tradeoffs between brightness, efficiency, and operating life. A total of 72 of this type LEDs, for example, would consume in total approximately 100 watts of power.

### Mechanical Considerations/Combined LED Operation

To produce an aggregate lighting arrangement with an overall desired lighting pattern and intensity, multiple LEDs may be arranged with multiple hollows within or atop a support plate. Here, each sub-housing has its own independent reflector and/or refractor optical system.

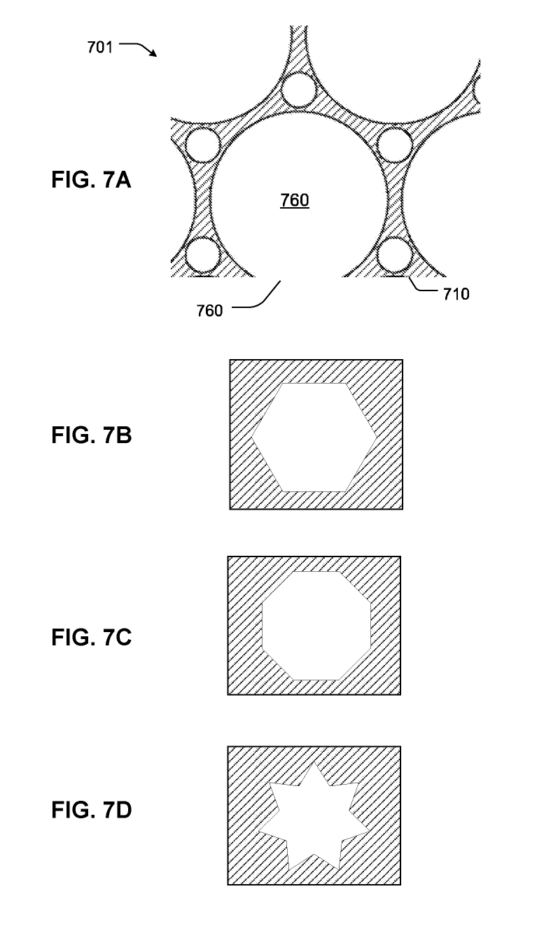

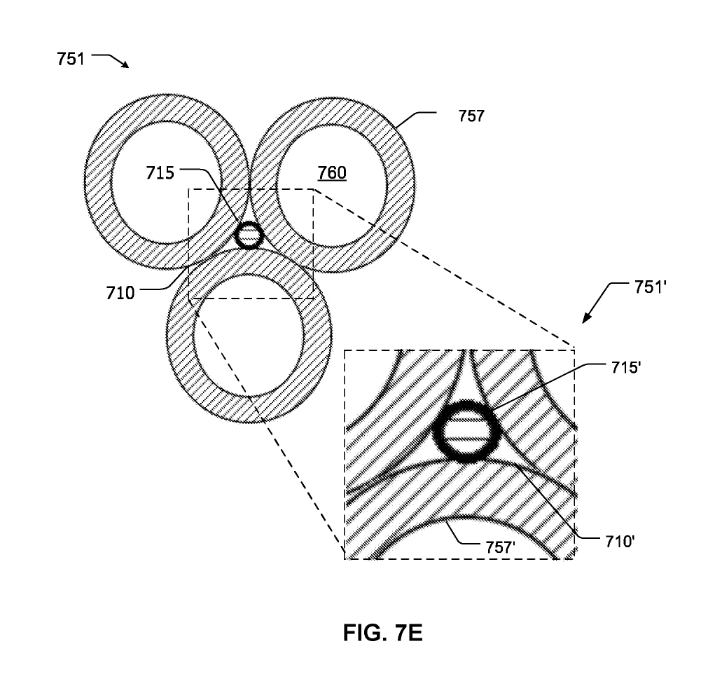

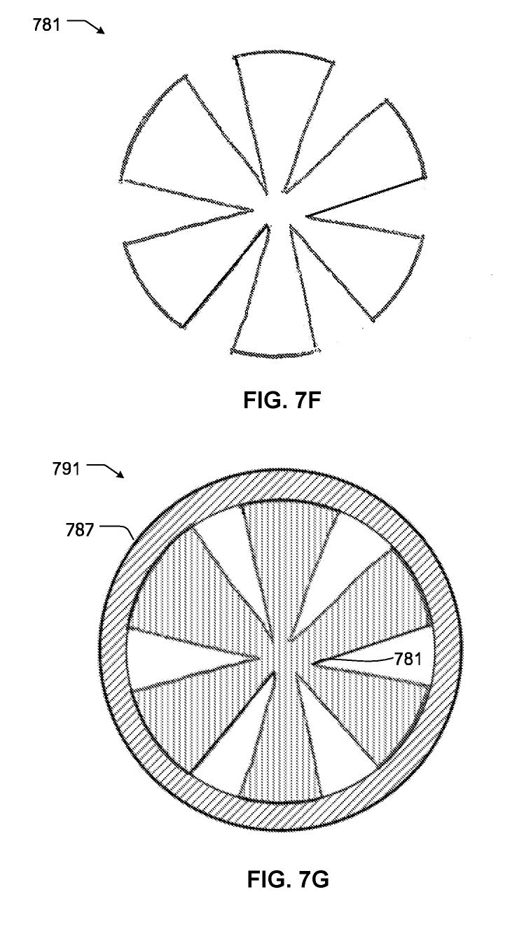

A primary support plate role is to provide a pre-determined arrangement of channels (or hollows) through which individual LEDs may shine. Another primary role is to facilitate cooling by allowing airflow. For this purpose, heat channels may be placed around each LED hollow, for example as featured in FIG. 7A, depicting a plate configuration 701 that could be cut from a solid sheet. Still other hole patterns are shown in FIG. 7B-D, depicting other shapes such as a hexagon in FIG. 7B or octagon in FIG. 7C, or even a hole design in FIG. 7D with rough or irregular edges that could be used. These other shapes may permit more heat transfer than a circular cross section, the latter which minimizes the perimeter for a given cross section area.

Alternatively, FIG. 7E features a plate design 751 that could be made from rings 757 of material, for example to surround an LED 715 within the gap area 710 defined by the junction of three rings 757. An appropriate thermally conductive material could be placed within the junctions formed by three rings 757 in close contact, to conduct heat away from an LED 715 within each gap 710. Region 760 shows an air vent formed from the otherwise empty space within a ring 757. A magnified view 751′, with primed identifying numerals, further details the space 710′ made at the conjunction of three rings 757′. Rather than a plate with a series of holes, the LED support structure could be considered or constructed as a framework of bridges between LEDs with gaps in between bridges.

As a further improvement to the channel or air vent heat transfer characteristic, one or more heat sink elements may be deployed within at least one channel path. This concept is shown in FIG. 7F with a six-lobed structure 781 that may be inserted into a channel border 787 as shown in FIG. 7G. The shape of the insert 781 is arbitrary but should make good thermal contact with the walls of the channel border 787 and present high surface area without inhibiting airflow. Optionally, the lobed structure of insert 781 may be made by cutting a flat round sheet in a way similar to that of cutting a pizza into slices; but the cuts would not extend all the way to the center of the sheet, allowing the lobes of 781 to remain attached. The lobes may then be twisted at a slant relative to the plane of the original sheet in something of a “louvered” fashion, thus allowing air to flow past the insert 781. The insert 781 may be attached to within the channel border with thermally conductive solder, weldment, or other attachment means; or optionally press fit into the channel with the option of applying thermally conductive paste (not shown) at the interface between the insert 781 and the channel border 787.

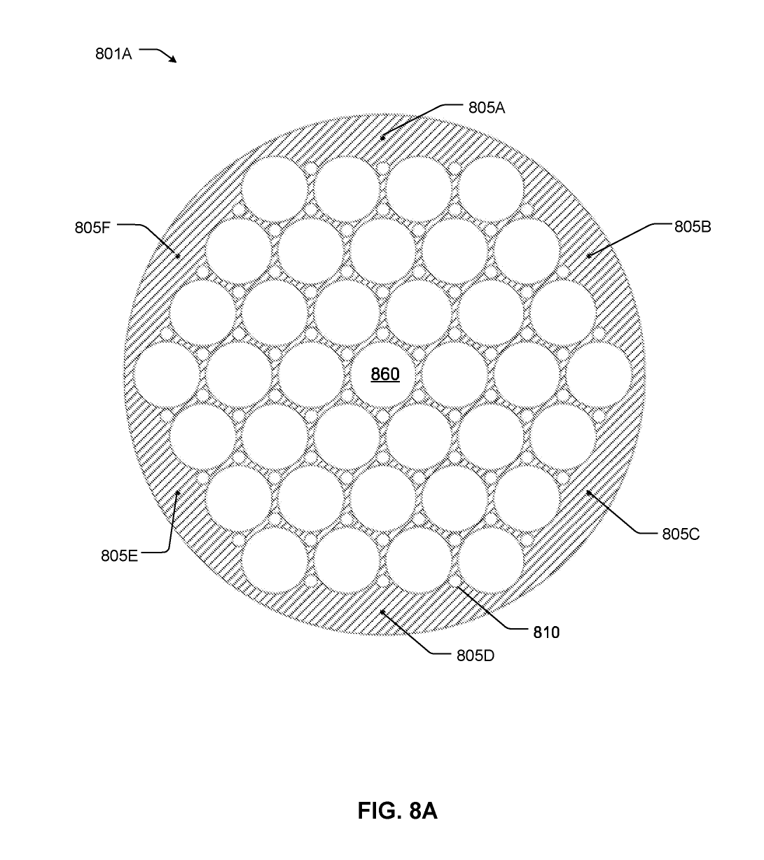

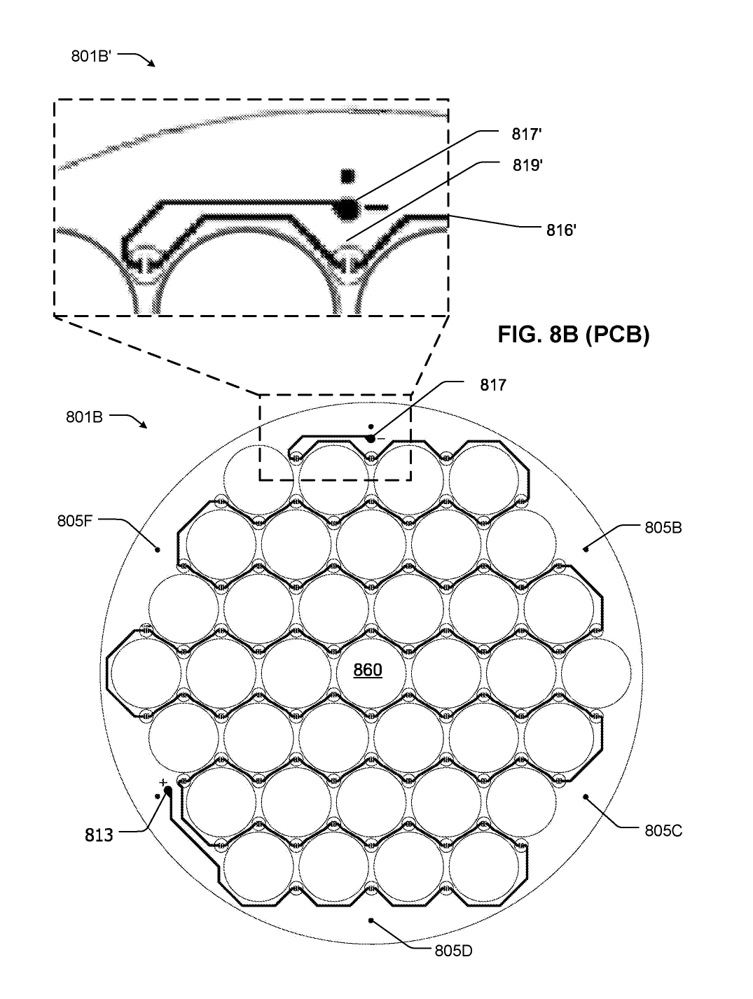

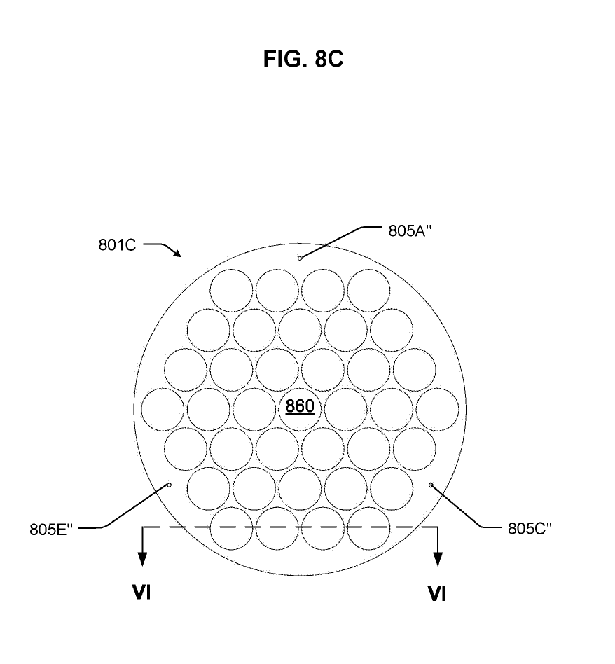

FIG. 8A shows a plan view of support plate 801 with LED hollows 810 and heat vents 860. FIG. 8B shows printed circuit board PCB 801b that is configured to be mounted directly on top of the support plate 801A. This PCB 801B has electrode tie points 813 and 817 separated at 120 degrees from each other to fit a preferred embodiment with three struts. However, a different number of struts may be arranged at angles besides 120 degrees. As a result, electrode tie points such as 813 and 817 may be routed at a corresponding strut angular separation to match strut position in case struts number other than three. To further detail the circuit board shown in 801B, inset 801B′ shows conductors, for example circuit board trace 816′ and tie point 817′, as well as a foil area 819′ for a place to attach the leads of an LED (the LED not shown). FIG. 8C shows a heat sink 801C, that in turn may be used to make a “sandwich” with support plate 801A and PCB 801B.

Though the plan views show an overall circular disc like shape for each of structures 8A through 8C, other shapes such as hexagons or octagons could be used. Also, the number and pattern of holes for LEDs and thermal vents in this illustration is only for example. The reflector, circuit board, and heat sink layers may be joined with fasteners at a plurality of holes, for example at points 805A, 805B, and 805C through 805F. Further, the layers may be sealed with a thin coat of silicone to make the sub-assembly waterproof.

FIGS. 8A and 8B show six mounting holes 805A-F for the plate 801A and PCB 801B fasteners. However FIG. 8C shows heat sink 801C fashioned with only three holes on one side but (the opposite side not shown because six matching holes are depicted in FIGS. 8A and 8B). In this embodiment the heat sink assembly allows six holes for fasteners to join with the plate 801A and PCB 801B, and three holes 805A″, 805C″, and 805E″ on the other side of the heat sink to engage with three struts (not shown in this figure). This way some mounting holes will not be upwardly exposed to the external environment for liquids or dust to settle into.

The heat sink may be made from aluminum. To save on costs, the heat sink could also be made from a thermally conductive plastic or polymer. Perhaps this latter option would be cost effective for cooler environments.

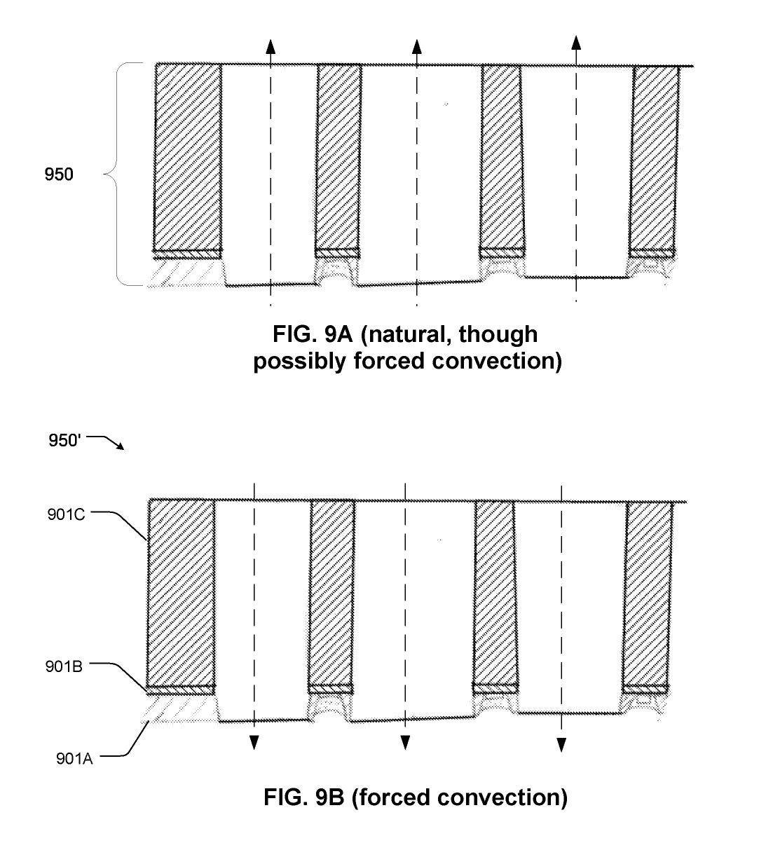

FIGS. 9A and 9B are based from a cross section roughly matching line VI-VI in FIG. 8C (with features in 8A, 8B, and 8C positioned adjoining each other—and for convenience of illustration, three vents are shown, not four.) FIGS. 9A and 9B show various plate assembly layers, including the support plate 901A, circuit board 901B, and heat sink 901C. Together these elements provide mechanical support, light path, and airflow. FIG. 9A also shows how natural airflow through convection might flow upward through the holes, and FIG. 9B shows how airflow might go downward if directed by a fan. Upward airflow could also occur with guidance from a fan, depending on the fan spin direction.

The heat sink layer 901C serves several roles, providing physical reinforcement as well as heat removal. Because the optical plate 901A and heat sink 901C reinforce the PCB 901B sandwiched in between, the PCB 901B may be made of flexible material.

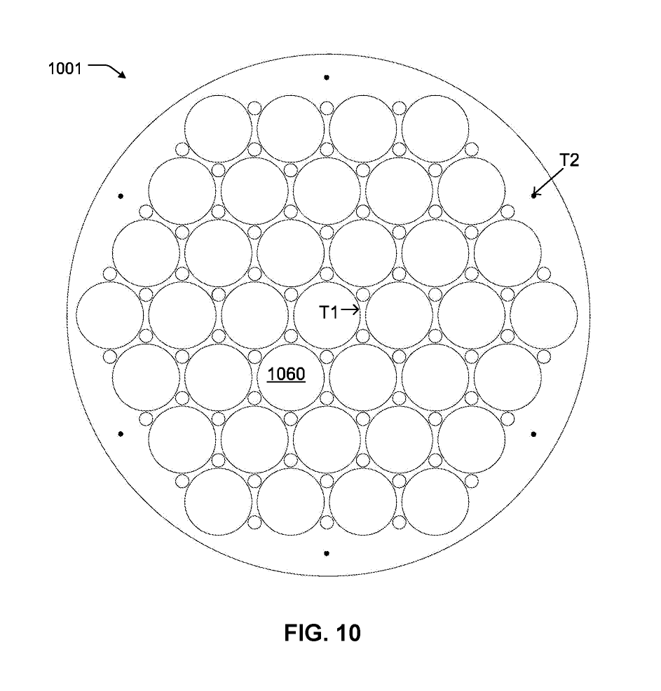

A uniform temperature across the plate is desirable to even the LED aging rate, since over time, hotter LEDs tend to discolor and fade. Favorably even in the absence of fan guided air flow, a generally uniform temperature distribution across the plate as shown in FIG. 10 may still occur. On plate 1001, sample points T1 at 44.6 degrees C., and T2 at 43.5 degrees C., represent actual measurements showing minimal temperature difference across the assembly. These measurements were taken at a 101 W power input and at 22.5 degrees C. ambient temperature.

Across the PCB, this measured delta temperature of around 1 degree C. is very favorable for consistent LED aging. This comparatively even temperature could well be an inherent effect of the “swiss cheese” cooling geometry featuring vents such as 1060 and shows an advantage over cooling methods using external fins.

Also favorably, observations showed the plate delta temperature rise to be about 25 degrees C. over ambient with about 100 watts input. This lower temperature rise would be less likely to age LEDs, than for example the 50 plus degree Celsius temperature elevation over ambient observed on at least one competing prior art luminaire.

To further ensure even heating across the heat sink and LED electronics, a fan may be deployed in such a way to spread airflow cooling evenly across the plate. Possibly greater airflow toward the center or away from the center may benefit in some circumstances. However, again even without a fan the minimal delta temperature across the heat sink and LEDs is favorable for consistent LED aging.

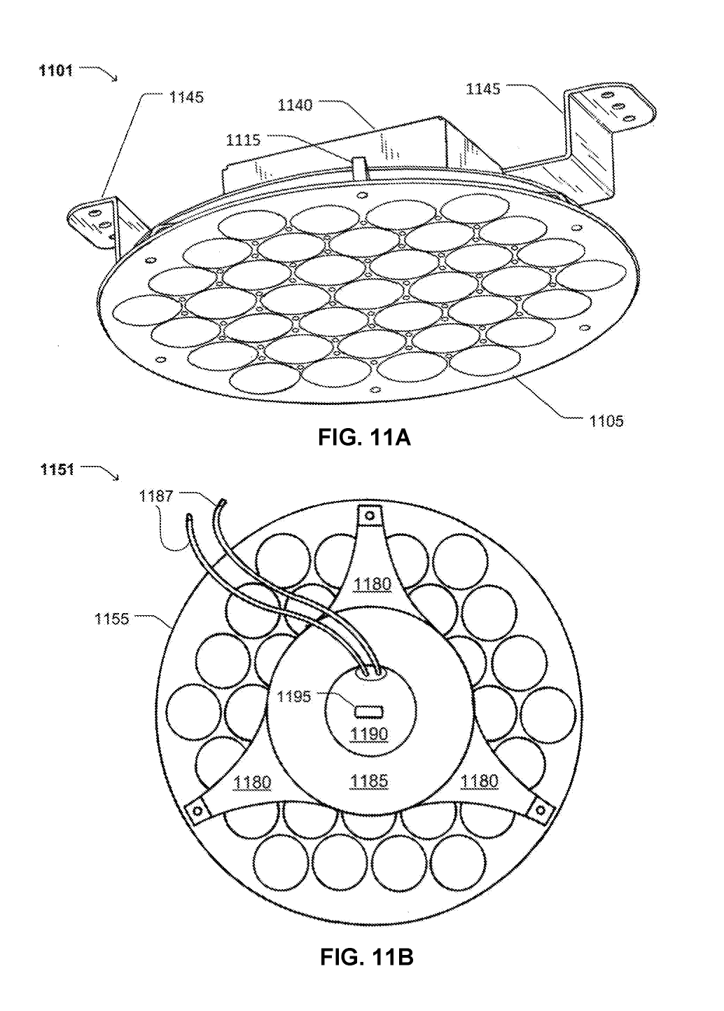

To deploy the plate assembly for use as a replacement High Bay luminaire, various configurations for mounting to a building or other structure are possible. Turning now to FIG. 11A, the base 1105 may be attached to a mounting hub/power supply case 1140 via struts 1115. As shown in FIG. 11A, a possible adaptation for mounting to an external structure is to provide wings or brackets 1445 protruding from the case 1140 for direct mounting to a ceiling or other structural element. The connection to these brackets may be detachable. Further discussion and illustration of how to use flanges to mount a luminaire to a building is provided in U.S. Pat. No. 9,285,081, LED HIGH BAY LIGHTING SOURCE, again here incorporated in its entirety by reference.

Alternatively, a hook or other conventional support means (not shown) may also extend from the mounting hub/power supply case 1140 to allow support from a structure such as a building ceiling or girder (also not shown).

As featured in FIG. 11B, yet alternatively, a tab 1195 may extend from the top cap 1190 that in turn extends from power supply case 1185. Tab 1195 may have an eyelet (not shown from the angle of this plan view) to also allow support of structure 1151 via hook or cable or other conventional support means. Wires 1187 may extend from cap 1190.

The struts 1180 may be curved or shaped so as to serve a decorative as well as practical purpose. An optional dust cover (not shown) is also possible in conjunction with FIGS. 11A-B.

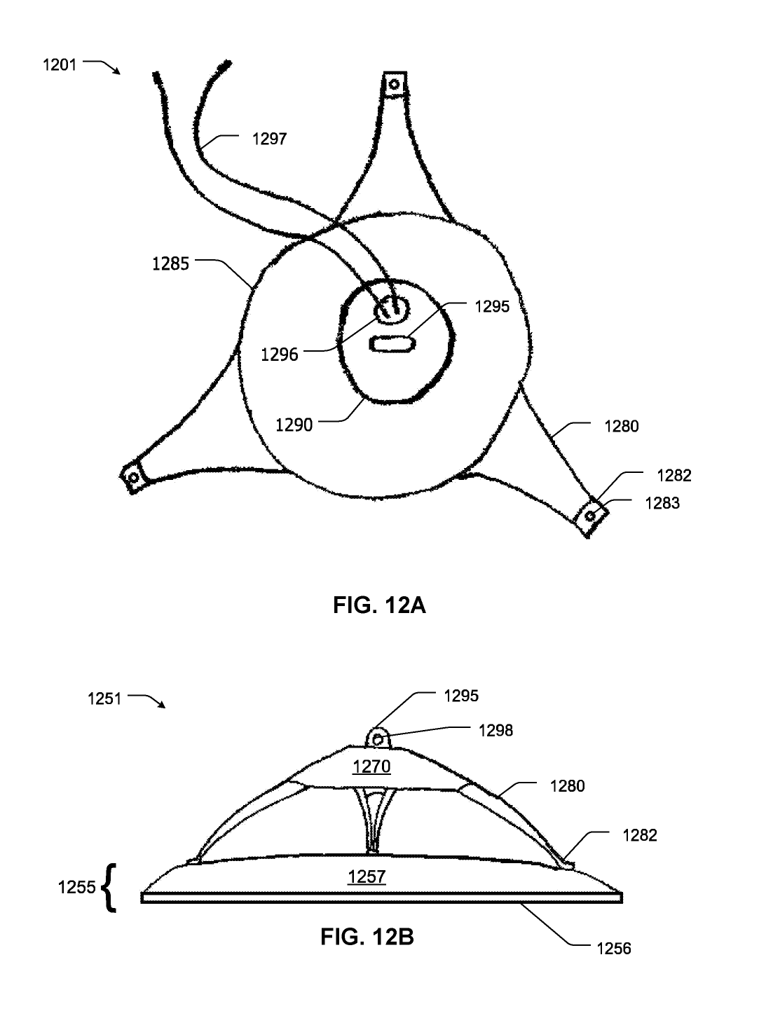

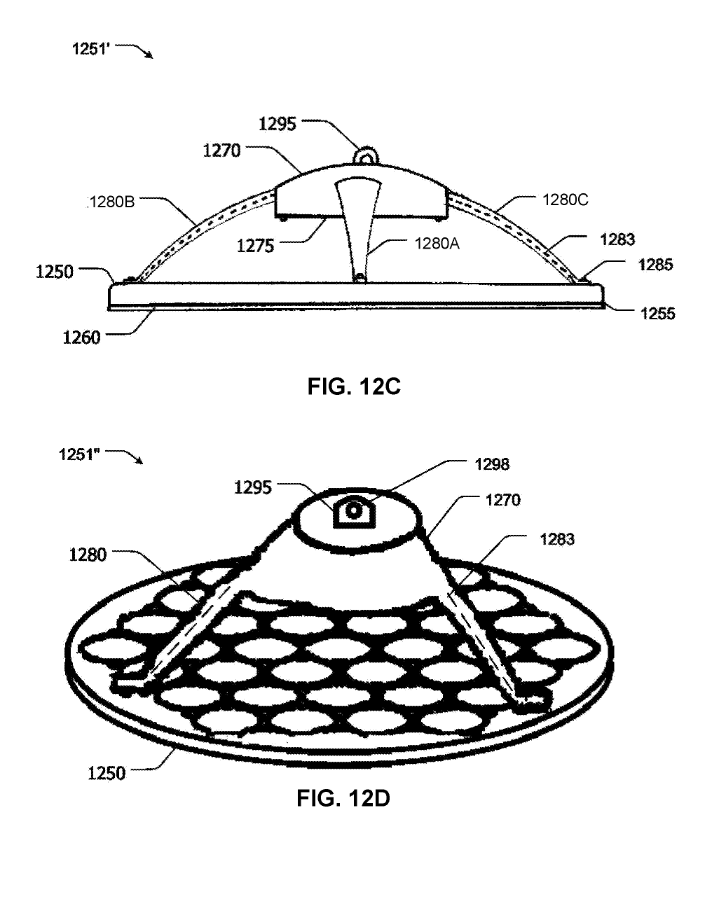

FIG. 12A details the support structure 1201 suitable for attachment to a plate (here not shown) corresponding to plate 1155 as in FIG. 11B. Everything is essentially as in FIG. 11B (minus the plate), but here detail is provided about the feet 1282 extending from struts 1280, the feet having in turn holes 1283 for fasteners. In this embodiment the cap 1290 is shaped similarly to a disk though other shapes, such as a square, could serve for this purpose of providing a nexus for struts and a link to a mounting projection 1195. The cap 1290 could be made as a casting.

As shown in elevation view FIG. 12B, cap 1290 provides a mounting projection 1295 having an eyelet 1298 from which a supporting cable or wire (not shown) could extend. The struts 1280 extend from the external support attachment 1290 over to a plate body 1255.

As shown in this Figure, the struts 1280 are bow-shaped, though other shapes are possible. Also the plate structure 1255 is shown with a sloped upper contour, as the top surface of the heat sink need not be entirely planar. In other words, the heat sink 1257 periphery need not be vertical over the optical plate 1256, but may be sloped for aesthetic or other reasons. A slope could help reduce dust buildup. Further, a sloped heat sink could even temperature across the plate through a mode of less cooling at the plate extremities.

FIG. 12C shows variations on the structure 1251′ as compared to FIGS. 12A and 12B. To clarify the previously mentioned parts in relation to the whole, here element 1250 is the heat sink disk, element 1255 is the PCB, and element 1260 is the optical plate. Again, from the mounting support 1290, a conventional hook may allow connection to a rope, chain, or cable for in turn connecting to a ceiling or other structural support. As further shown in FIG. 12C, the struts 1280 may be hollow or have one or more grooves to facilitate the routing of wires 1283. As implied with the wide separation of struts 1280 in this diagram, four struts 1280 may extend at right angles from hub 1270; from this perspective a fourth strut 1280D is hidden behind strut 1280A. If needed, an access cover 1275 may extend from the lower side of cap 1270.

For embodiments using a fan, the fan motor support and/or housing may either extend above the plate 1250, or below the cap/hub 1270, or serve to bridge between both.

Finally, FIG. 12D shows a perspective view (one strut hidden) of how a three strut support structure made of cap 1270 and struts 1280 may connect to the plate 1250. It is believed that a three strut support arrangement may be optimal to match the essentially hexagonal vent and LED arrangement as shown; however non-hexagonal vent geometries and non-triangular strut support are still within the scope of the invention.

Depending on the required protection from external elements, a housing cover (not shown in FIG. 12, but shown in FIG. 4) may surround core luminaire parts. For example, a skirt or girdle may surround the struts, for purposes including that of a dust shield to prevent dust ingress from reaching luminaire electronics.

### Thermal Considerations

Referring back to FIG. 8B, to further extend luminaire heat flow, one may design the PCB 801b to promote thermal conduction. This could be designed in either through choice of material that is thermally but not electrically conductive, or through a conductor layout with extra metallization, or both.

Referring back to FIG. 8A, beyond making room for LEDs and supporting optics, the optical plate 801A secondary role is to facilitate cooling. Choice of conductive material, such as aluminum, may aid in cooling. Additionally, radiative cooling may occur, or convective cooling via air holes or perforations for air to go through the plate surface. Referring back to FIGS. 7B-7C, the channel vent shapes may be circular or hexagonal for example. Alternatively, a star shaped cross section as in FIG. 7D may increase turbulence or air-solid heat exchange and therefore increase cooling. For a given vent opening cross section, a non-circular cross section may present more air contact area to improve heat transfer. Again, various possible vent cross sections are shown in FIG. 7.

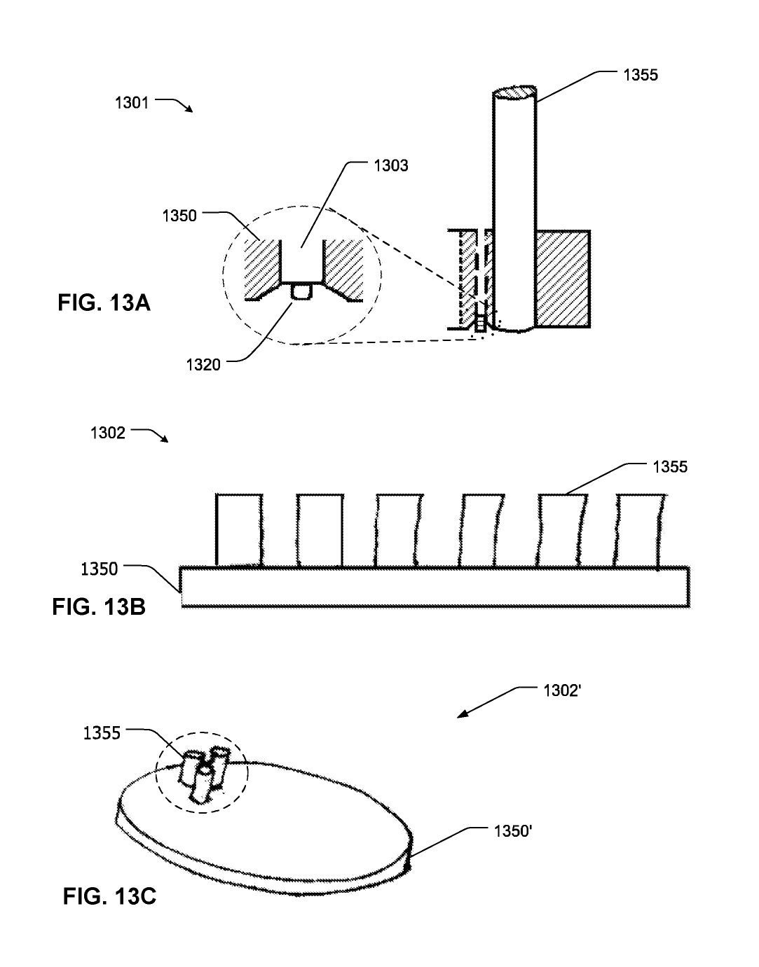

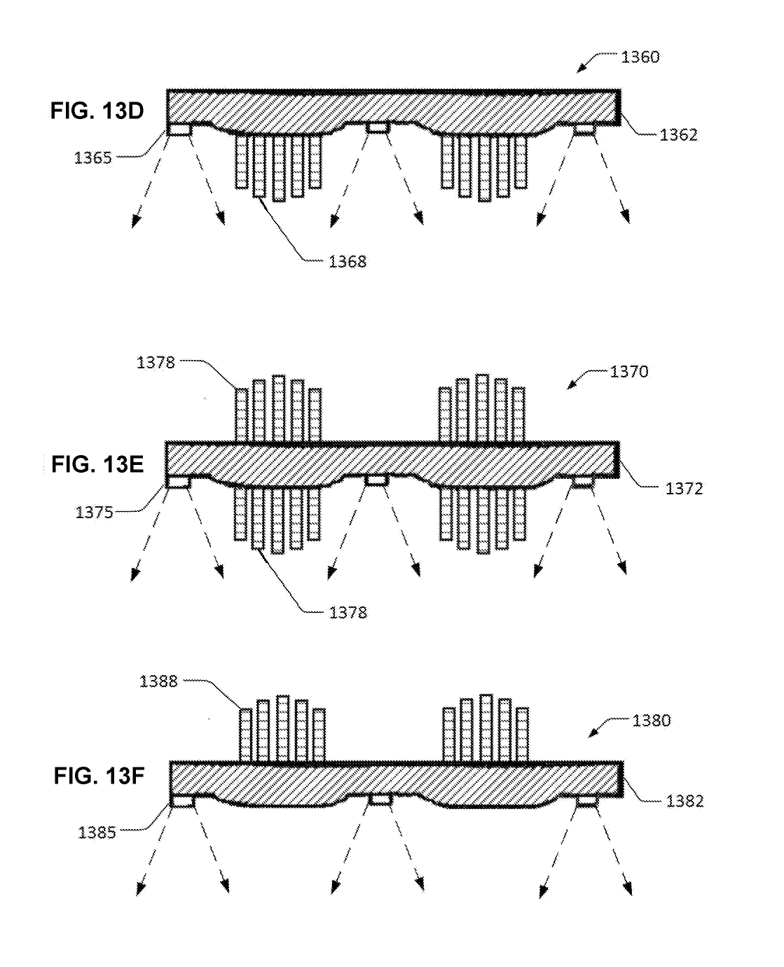

Further, FIG. 13A features a heat sink variation 1301 with an opening 1303 adjacent to at least one LED 1315 positioned on the PCB 1320. This open region 1303 would act as a “heat chimney” release duct. As another advantage, provision of one or more chimney gaps 1303, or hollowed out areas 1303 in heat sink plate 1350 opposite the LED 1320 shine path, reduces the amount of material needed to make the heat sink. While in some environments having a duct directly above an LED may in the long run risk the possibility of moisture or dust accumulation, under some circumstances this duct 1303 option may contribute to cooling while reducing the amount of material needed in heat sink plate 1350 construction.

As shown in FIGS. 13B-13C, another cooling option is an elongated radiator 1355 that may function as an “air vent chimney”. An extension of one or more heat conductive pipes or tubes 1355 from the heat sink 1350 may also benefit in that a double surface area extends from inside and outside each tube 1355. This double surface area in contact with surrounding air would likely increase heat transfer.

FIG. 13B shows an example side view of a plurality of heat pipes 1355 extending from the heat sink 1350, and FIG. 13C is a perspective representation of multiple pipes 1355 extending from a heat sink 1350′. Only three pipes 1355 are shown extending from this particular Figure; however other pipes (not shown) could be arranged uniformly or otherwise distributed across the heat sink 1350.

If uneven temperature across plate 1350 became an issue, the height of the projecting air pipes 1355 could be changed on a case by case basis to even the temperature.

Ideally, enough convection should occur just based on heat rising from the LEDs, or possibly control electronics if present, to establish a convective air flow to promote cooling.

However optionally, a fan may deliver air flow through the luminaire base, providing cooling to the lighting system and beyond its immediate environment. As an additional benefit, if used to push air downward, this fan may act to de-stratify the surrounding region, to spread heat from the ceiling level down toward floor level. The use of thermal energy produced from lighting elements to reverse thermal gradients and make a room's temperature more consistent between the floor and ceiling extends benefits beyond just being a lighting system.

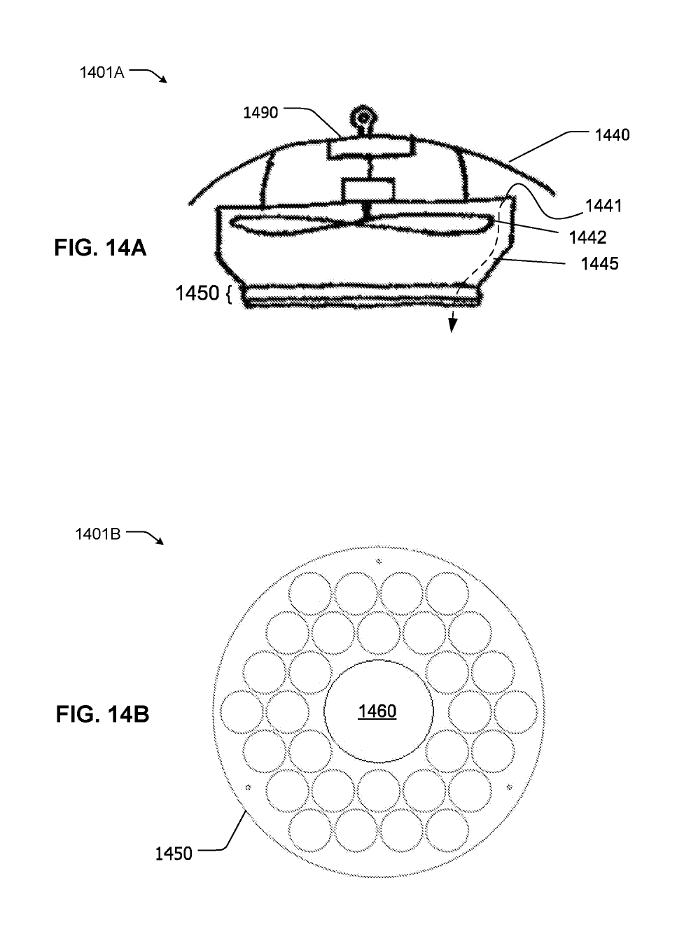

FIG. 14A shows a fan 1442 directed air flow embodiment 1401A, featuring a guided air path 1441 starting from a hood 1440, protecting elements beneath. Air funnel 1445 allows air intake for ducting to a base structure 1450, the latter of construction as in FIGS. 8 and 9. If a fan 1442 is used, it may be placed between the power supply case 1490 and the base 1450, but other deployment locations are possible.

As shown in FIG. 14B, the base 1450 may have a larger central hole 1460 than in other embodiments, to facilitate a fan driven air path to proceed through. Other hole resizing is possible to allow more air to evenly flow through under propulsion from a fan 1442.

Alternatively, instead of a system of vent holes, a series of projections may protrude from the plate to remove heat. This concept is depicted in FIGS. 13E-13F showing a series of small projections 1368, 1378, and 1388 from the heat sink plate diagrams 1362, 1372, and 1382 respectively. This provides an option to reduce air flow through the system, if needed, while still providing favorable thermal emission properties. As needed, a combination of projections and air vents may be used to facilitate heat relief and even temperatures across the luminaire.

### Electrical Considerations

As shown in FIG. 8B, the PCB electrical terminals 803 and 807 are spaced 120 degrees apart for joining with external wires (not shown in this Figure, but as 1283 in FIG. 12D) fed from struts (not shown in this Figure but as 1280 in FIG. 12D). This particular angular separation is not required and depends only on the relative angle of the struts, as varying numbers of struts may be used instead of just three.

An arrangement showing power being fed from the mains to the light plate is featured in FIGS. 12C and 12D which show wires 1283 as dashed lines extending from the power supply case 1270 going along two of struts 1280 to the main plate 1250. In FIG. 12C, per standard construction, the power supply case 1270 may have a cover plate 1275 to shield an opening. A large cover (not shown) may also be placed above the struts 1280 and case 1270 which can be important around food preparation environments to meet ingress protection requirements.

From the power mains, a THHN (Thermoplastic High Heat Nylon) coated conductor may be adapted to a ROMEX® cable connector. Typically the ROMEX cable has insulated wires bundled within a plastic sheath, as opposed to wires within a metal conduit, though the latter may also be used.

Again, separate conductors may extend through each leg/strut of the mounting structure to feed power to the LEDs, possibly after going through a voltage or current modifying circuit (not shown) contained in the top cap 1270. If a fan is in place, electricity may be diverted from the conductors along the struts and routed to the fan, or the fan may be fed directly from a circuit in the top cap. Conventional circuitry to transform AC or DC mains power into a form suitable for powering LEDs is known in the art.

While the circuit board shown in FIG. 8B has circuit traces 816′ for LED connections 819′ only, it would be possible to also include bypass elements for each LED so that if one stops working, current would continue to flow through the other LEDs. This capability is disclosed in U.S. Pat. No. 9,022,608 entitled “Multiple Positioned Light Source and Protection Circuitry Therefor”, issued on May 5, 2015. From there, means of translating a schematic to circuit board traces and physical component arrangement are well known in the art.

### Operation

When electricity is provided to the unit, various activation options are possible. If present, the fan may start immediately. Control electronics may instead start the fan after some delay since turn on. Alternatively, the fan may not be turned on until a sensor reaches a predetermined temperature. The determination of both whether to activate the fan and the fan speed setting may be temperature controlled. Other possible activation modes may be used, for example a combination of a timer alone or in combination with indoor or outdoor condition sensors.

To support room air destratification, the fan could be controlled to operate so that cool air below is drawn upward, or if multiple luminaires are in place, some fans were arranged to draw air upward, and others downward. Further, the fans could be remote controlled via ZigBee®, WiFi®, or other wireless or power line data carrier to act in concert to obtain the desired cooling or air redistribution pattern. A combined deployment of luminaires with fans, and fans without lighting capability may also reduce stratification. All of this could be orchestrated by a central building temperature controller.

### ALTERNATIVE EMBODIMENTS OF VARIOUS COMPONENTS

The areas adjoining each LED hollow may serve a further optical purpose. If the sides of each hollow are not fully coated with reflective material, and the plate material is at least partially translucent, the side light emerging from each LED could be re-directed through plate material diffusion. This side emitted LED light may thus be redirected, eventually emerging downward so as to illuminate the desired surface, thus adding to overall system efficiency. Different levels of internal translucence and different amounts of “frosty” surface treatment would produce different lighting effects. Further, small holes could be formed into the translucent material to make possible a variety of pathways for light to re-emerge. In some configurations, these holes could act as light shafts, thus redirecting side emitted light from an LED to a direction parallel to a shaft. While a diffuser directly in the path of the main optical axis of an LED can be counterproductive, a diffuser to recapture and redirect side emitted light can be helpful in a mixed strategy combining a direct LED beam on some angles and a diffuser redirect for other emission angles.

Further, the local LED optics need not be symmetrical to produce a desired overall pattern, because a combination of asymmetrical optics across numerous LEDs can produce overall symmetrical illumination. There may also be occasions where asymmetric aggregate light output would be desirable.

As a further modification, lens material could contain colloidal phosphor which would be excited by an LED of appropriate color, for example royal blue defined by Cree Semiconductor at about 450 nanometer wavelength. This phosphor could further distribute the light from the central LED and reduce hot spots.

If non electrically conductive plate material is used, the optical plate could have holes formed to accept LED leads. With a non-electrically conductive plate material, a deposition or etching process could be used to produce a framework of appropriate conductors and insulators to supply LED electricity. This could result in not needing a separate printed circuit board.

The heat sink could also be modified to provide support for electrical conductors and LEDs. For example, the company TT Electronics produces thick film material, opening the possibility that an insulator and circuit traces could be deposited on the heat sink. This would also make unnecessary a separate PCB. However, the expansion characteristic of the thick film would have to be made similar to that of the aluminum or other heat sink material in order to maintain structural integrity.

### CONCLUSIONS, RAMIFICATIONS, AND SCOPE

As described, this design makes effective LED use with a multitude of local reflectors instead of one large reflector. This “open frame” construction allows more efficient air throughput.

While in the baseline version, at least some LEDs are placed within a hollow, a concave hollow region may be either defined by the plate, or by an attachment affixed to the plate, or both.

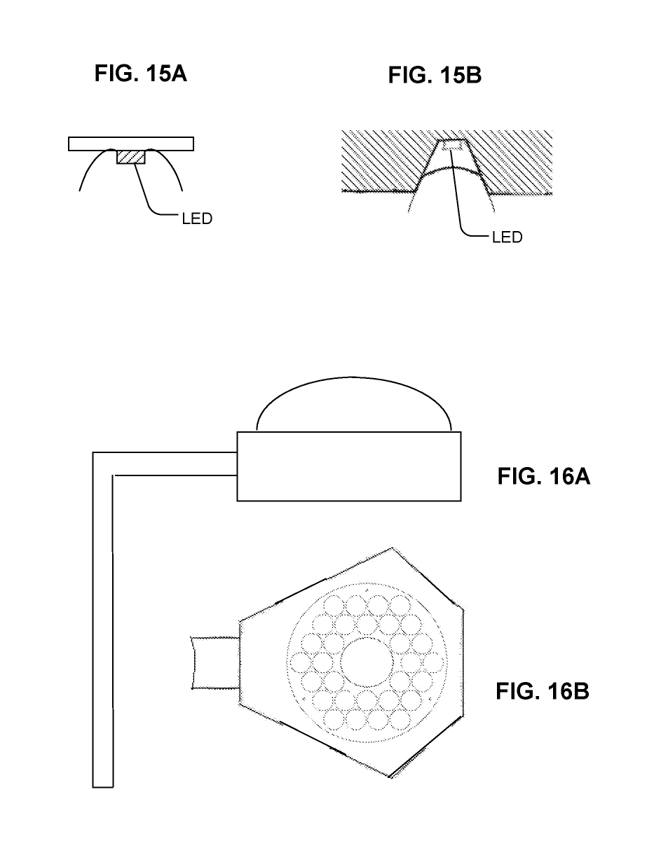

In other words, an LED hollow may be wholly recessed in the plate, or extend as a reflector cone from the plate surface. The LED hollow may even be a combination of plate recess and extending cone. Also, the word “cone” is not intended to limit the contour shape strictly to a geometric cone with a smooth taper from the base to the surface, but rather to generalize to a concave structure. Examples of alternate reflector optics are shown in FIGS. 15A and 15B. Lenses, not shown, whether formed in situ from a liquid, or conventionally made from a solid, may also be used in conjunction with these optical arrangements.

Additionally, more than one LED or point source may be within an optical hollow, though the hollow geometry may need to be changed to accommodate multiple sources. Other small size lighting sources besides LEDs could be used in the construction.

Further, though the luminaires as shown are essentially circular, the concept of providing air vent holes in between LEDs could be extended to form a linear, rectangular or other geometric plate form envelope to cool LEDs.

While the plate was conceived to be essentially planar for its role as a point source support structure in a lighting system, this need not be the case. A modified plate would also be possible as a tiered or dome shaped support system. Further, while individual LEDs are shown placed to emit parallel beams in disclosed implementation, this need not be the case. The beams could be pointed in varying directions to obtain ideal lighting conditions, depending on the application.

A side benefit may result from configuring a plate with large air holes between little reflector hollows. With sufficient fan speed, air flowing through the plate may go beyond the lighting system to thermally de-stratify the surrounding air. This may be beneficial in a room, warehouse, or otherwise enclosed space.

By integrating the illuminating function of a lamp and destratification function of a fan into one assembly, cost and space savings is reached with increased functionality.

While there are benefits with air temperature destratification for indoor use, the assembly may also be deployed outdoors. For example, the use of the lighting system as an overhead street light is shown in FIGS. 16A-16B. Thus, an LED High Bay luminaire could also replace a conventional sodium vapor lamp.

Furthermore, to optimize cooling the choice of holes within the plate or thermally conductive projections from the plate is not an either/or option. Thermal projection elements could be used in combination with holes to produce desired thermal distribution effects.

As a whole, this development provides a novel arrangement of light sources, air path, and light directive material. Thus, this development is an effective way to provide lighting and possibly serve other useful purposes.

It is thought that the multiple emission source multiple cooling path lighting system of the present invention and many of its attendant advantages will be understood from the foregoing description and that it will be apparent that various changes may be made in the form, construction, and arrangement of the parts thereof without departing from the spirit and scope of the invention or sacrificing all of its material advantages. The forms described above are merely preferred or exemplary embodiments. The invention is defined in the claims.

What is claimed is:

1) A lighting system, comprising:
at least one light emitting element;
a plate with at least one perforation allowing air to pass through the plate; and
the plate having at least one optical hollow, wherein the at least one light producing element is inserted within the at least one optical hollow.

2. The lighting system as in claim 1, the at least one optical hollow having a concave cross section for reflecting light in a desired direction.

3. The lighting system as in claim 2, further comprising at least one refractive element affixed to the plate and covering over at least a portion of the at least one optical hollow;
wherein the refractive covering redirects emission from the at least one lighting element.

4. The lighting system as in claim 1, further comprising a fan for providing cooling.

5. The lighting system as in claim 4, the fan adjusted so as to have an effect on the air temperature distribution in the lighting system surroundings.

6. The lighting system as in claim 5, the at least one insertion point having a concave section for reflecting light.

7. The lighting system as in claim 6, having: a meniscus covering at least some of the at least one insertion point;
wherein the meniscus focuses the at least one lighting element as needed to obtain a directed lighting pattern.

8) A method of forming a light directing element, the method comprising;
pouring or injecting liquid into a hollow; and
cooling the liquid to a solid.

9) A method of forming a light directing element, the method comprising;
pouring or injecting liquid into a hollow having boundaries, the hollow oriented to receive said liquid;
wherein a meniscus forms from contact between liquid and boundaries of the hollow; and
allowing the liquid to cool or chemically transform to a hardened state.

10) A method of illumination, comprising:
forming a sheet or block of material through making substantially concave insertion points for light producing elements, the concave insertion points being drilled in the material or mounted to the material; and
placing light producing elements in the insertion points.

11. The method of illumination as in claim 10, further comprising:
cooling the light producing elements with a fan that produces enough air flow to thermally destratify the surroundings.

11. The method of illumination as in claim 10, further comprising:
making holes in the plate, between the LEDs.

12. The method of illumination as in claim 10, further comprising:
cooling the light producing elements with a fan that produces enough air flow to thermally destratify the surroundings.
